(19) United States
(12) Patent Application Publication
(10) Pub. No.: US 2015/0226367 A1
(43) Pub. Date: Aug. 13, 2015

(54) ACTUATOR FOR AN IN-LINE VACUUM JACKETED CONTROL VALVE FOR CRYOGENIC FLUIDS

(71) Applicant: CREARE INCORPORATED, Hanover, NH (US)

(72) Inventors: Michael Phillip Day, Cornish, NH (US); John Kendall Sanders, Hartland, VT (US); Everett Edgar Archibald, Windsor, VT (US)

(21) Appl. No.: 14/426,651

(22) PCT Filed: Sep. 9, 2013
(86) PCT No.: PCT/US13/58704

§ 371 Date: Mar. 6, 2015

Related U.S. Application Data
(60) Provisional application No. 61/698,123, filed on Sep. 7, 2012.

(51) Int. Cl. F16L 59/16; F17C 13/04; F16L 59/065

(52) U.S. Cl. CPC F16L 59/161; F16L 59/16; F16L 59/065; F17C 13/04

(57) ABSTRACT

A valve and an actuator for vacuum insulated line includes a housing that attaches to the vacuum insulated line. A valve is positioned in the vacuum insulated line, so that the vacuum that insulates the line from ambient temperature also insulates the valve from ambient temperature.

This application claims priority of U.S. provisional application Ser. No. 61/698,123 filed Sep. 7, 2012.

This invention was made with Government support under Contract No. SP4701-10-C-0029 awarded by the Defense Logistics Agency (DLA). The Government has certain rights in the invention.

### FIELD

The device relates to an actuator for an in-line vacuum jacketed control valve for cryogenic fluids that is able to be installed on and removed from a line without creating a break in the line.

### BACKGROUND

Modern machining processes are increasingly being performed at cryogenic temperatures to achieve improved results. Typically, cryogen is delivered from a supply source to the machining zone through a vacuum insulated line. The vacuum insulated line may comprise an inner line containing the cryogen and an outer line which is exposed to ambient temperatures with a vacuum being maintained between the two lines. In order to be able to turn off the source of cryogen when it is not required, and to meter the flow of cryogen when less than full flow is needed, a valve has to be installed in the line. Any such valve has to be designed to minimize heat gain by the cryogen, and to be immune from frost and operational issues that are associated with frost. The valve should have minimal flow restriction in the open position, provide both on-off and metered flow control, and have minimal power requirements. The valve should also be designed for minimal component wear, and to prevent flow when power is lost. If the valve is installed in a vacuum insulated line, the vacuum in the line should be continuous with a vacuum that is maintained around the valve, and the need for a bellows connection to allow a change of length of the inner line relative to the outer line should be eliminated. The actuator for the valve should have a compact, low-profile design, and be able to be installed on and removed from the line for service and replacement without having to create a break in the line.

### SUMMARY OF THE DEVICE

An actuator for a control valve for cryogenic fluids in a vacuum insulated line comprises a housing that is clamped directly onto the line and a split annular magnet. The housing and the magnet may be installed on and removed from the line without disassembling the line. The vacuum in the insulated line surrounds the valve that is controlled by the actuator.

### BRIEF DESCRIPTION OF THE DRAWINGS

FIG. 1 is a perspective view of an actuator and a magnet for an in-line control valve.

FIG. 2 is a sectional view taken along line 2-2 of FIG. 1 showing the valve in a closed position.

FIG. 3 is a sectional view similar to FIG. 2 but showing the valve in an open position.

FIG. 4 is a sectional view taken along line 4-4 of FIG. 3.

FIG. 5 is a sectional view taken along line 5-5 of FIG. 2.

FIG. 6 is an exploded perspective view of the actuator and magnet of FIG. 1.

FIG. 7 is a view showing the actuator and magnet separated into pieces for removal from a line.

FIG. 8 shows an alternate form of the actuator that uses a cylindrical piston and piston housing to actuate the in-line control valve.

FIG. 9 shows an alternate form of the actuator that uses a linear variable position transducer to actuate the in-line control valve.

### DESCRIPTION OF THE PREFERRED EMBODIMENT

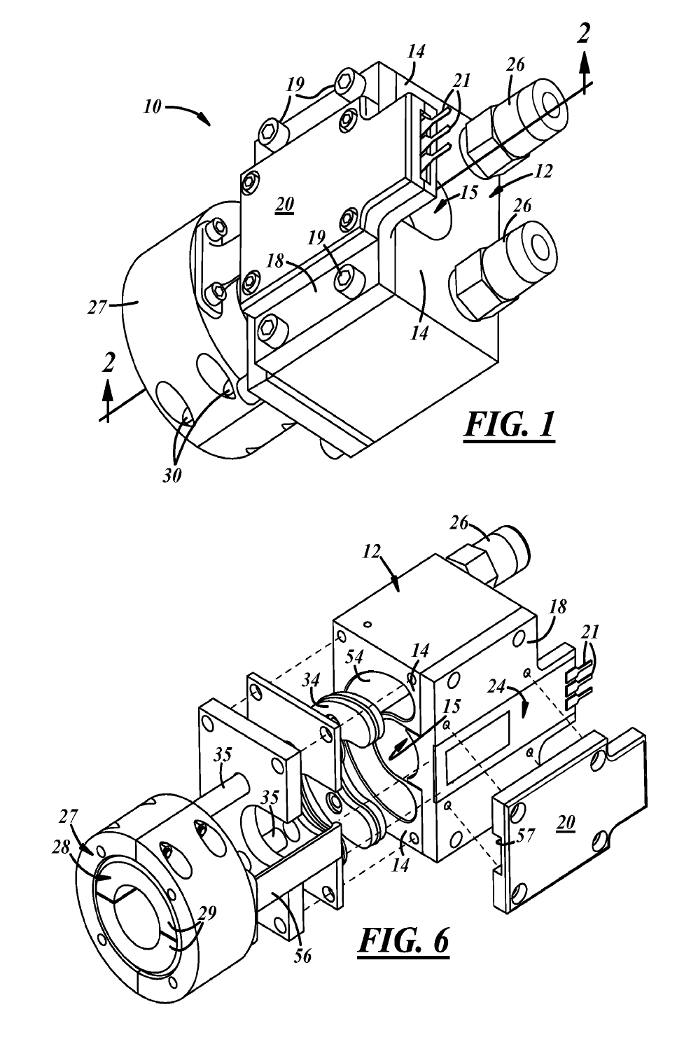

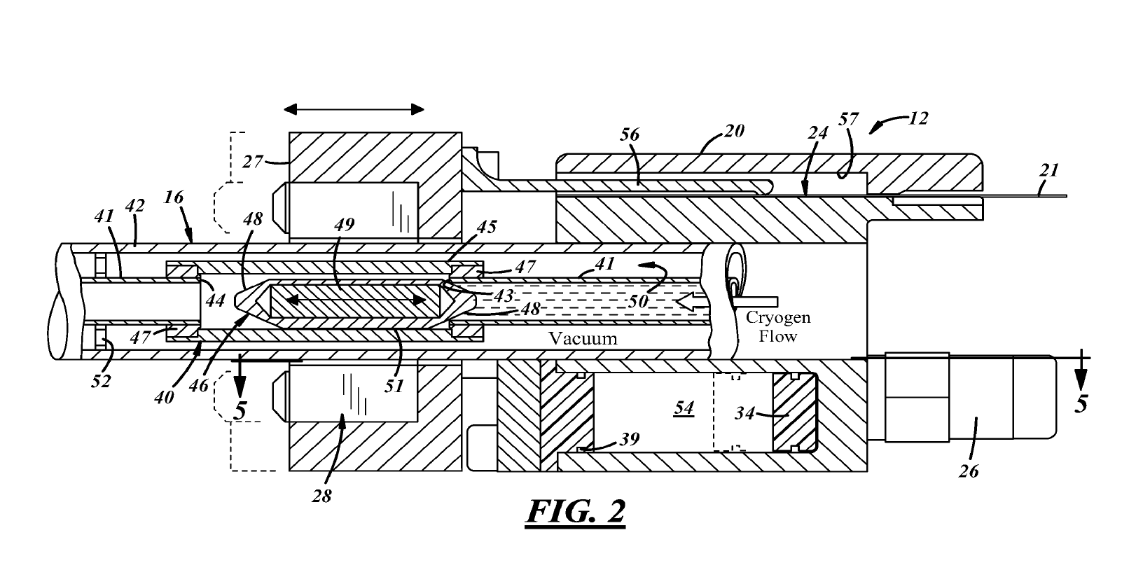

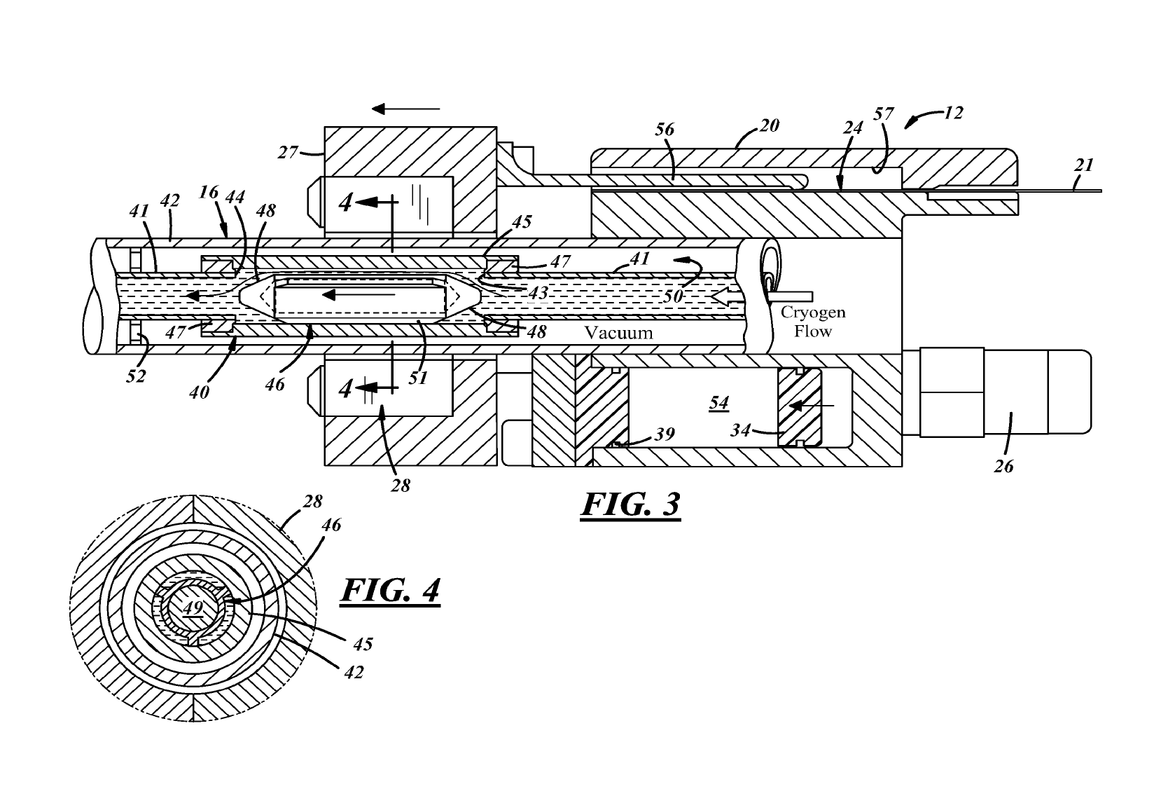

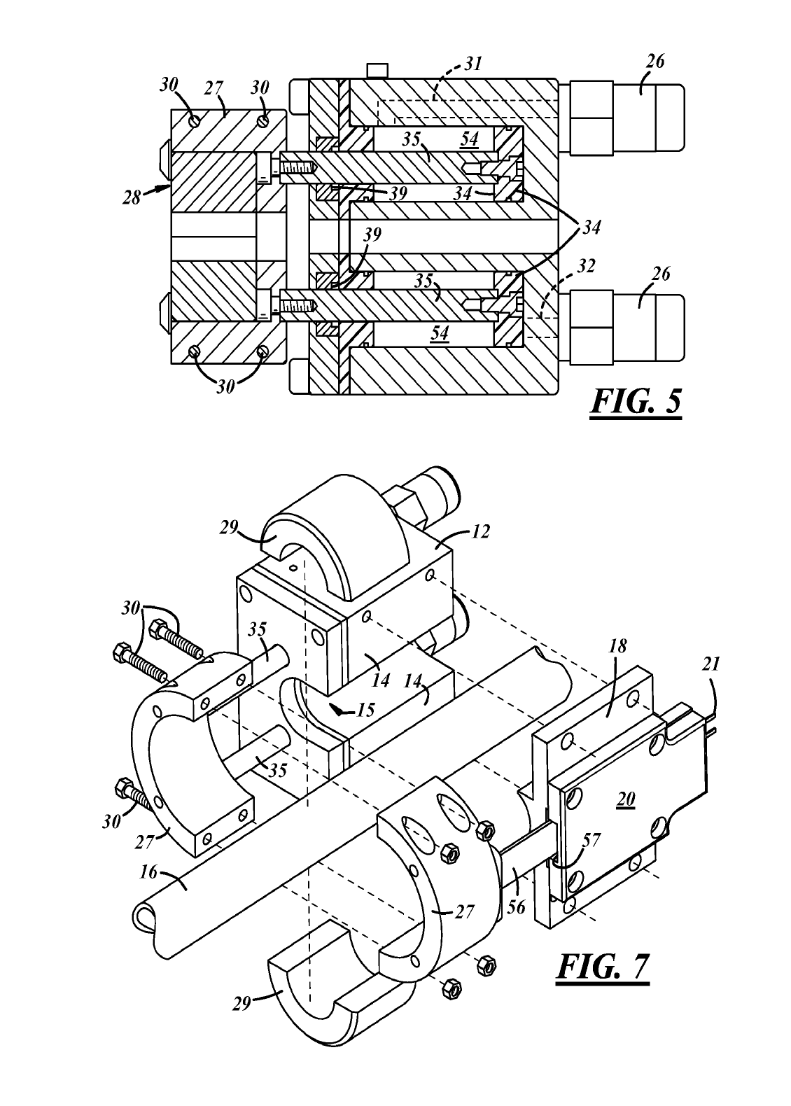

FIG. 1 is a perspective view of an actuator for an in-line control valve generally designated by the reference numeral 10. The actuator comprises a U-shaped housing 12 having two legs 14 that are spaced by a gap 15. The gap 15 formed between the two legs is dimensioned and shaped to fit around a vacuum insulated line 16 as shown in FIGS. 2 and 5. The ends of the two legs 14 are bridged by a keeper plate 18 that is attached to the two legs by threaded fasteners 19. Bolting the keeper plate 18 to the ends of the two legs 14 secures the housing 12 on the vacuum insulated line 16. A cover plate 20 is mounted on the keeper plate 18, and signal leads 21 extend from a potentiometer 24 (best seen in FIG. 6) that is mounted under the cover plate 20. A pair of pneumatic couplers 26 are mounted on the housing 12 and lead to opposite ends of a cylinder in the interior of the actuator housing. A two piece shell 27 is used to hold a two-piece annular magnet 28 that is suspended from one end of the actuator housing 12. Threaded fasteners 30 may be used to hold the two piece shell in place around the annular magnet 28. The annular magnet 28 surrounds a portion of the vacuum insulated line 16 that contains a control valve 40 (best seen in FIGS. 2 and 3).

FIG. 2 is a sectional view of the valve and actuator taken along lines 2-2 of FIG. 1 showing the valve in a closed position. FIG. 3 is a sectional view similar to FIG. 2 but showing the valve in an open position allowing cryogen to flow through the line 16. The vacuum insulated line 16 is designed to conduct cryogenic fluid, and the line 16 comprises an inner tube 41 surrounded by an outer tube 42 with a vacuum maintained in the space 50 between the two tubes to provide insulation for the cryogen in the inner tube 41. A control valve 40 is mounted in a portion of the vacuum insulated line 16 that extends outside of the housing 12. The valve 40 is positioned in the outer tube 42 and comprises a tubular valve body 45 that is coupled on either end to the inner tube 41 of the cryogen supply line. The coupling of the tubular valve body 45 to the inner tube 41 may be weld joints 47 or other coupling mechanism that provides a leak tight seal between the inner tube 41 and the tubular valve body 45. A perforated ring 52 may be installed between the inner tube 41 and the outer tube 42 to maintain the inner tube centered in the outer tube and to allow the propagation of the vacuum within the space 50 between the two tubes.

The tubular valve body 45 contains a movable shuttle valve element 46 that has opposed tapered ends 48 that engage an inlet seat 43 and an outlet seat 44, respectively, at the two ends of the tubular valve body 45 to control the flow of cryogen in the line 16. FIG. 2 shows in full the annular magnet 28 in a retracted position next to the end of the actuator housing 12 and the shuttle valve element 46 in a closed position against the inlet seat 43. FIG. 2 shows in phantom the magnet 28 in a fully extended position and the shuttle valve element 46 in a closed position against the outlet seat 44. FIG. 3 shows the valve element 46 in an open position between the inlet seat 43 and the outlet seat 44.

The shuttle valve element 46 comprises a central body 49 of magnetic material, or material that is attracted to a magnet. The annular magnet 28 is positioned around the portion of the outer tube 42 that surrounds the tubular valve body 45 and movement of the magnet 28 relative to the housing 12 is used to control the position of the shuttle 46 and the flow of cryogen through the inner tube 41. The vacuum that is maintained in the space 50 between the outer tube 42 and the inner tube 41 flows around and surrounds the valve 40. By positioning the tubular valve body 45 in the outer tube 42 and by using the vacuum from the outer tube to insulate the tubular valve body 45, the vacuum surrounding the valve body is reliably maintained with longer service life than if the valve 40 were insulated using a separate evacuated volume.

FIG. 4 is a sectional view taken along line 4-4 of FIG. 2 showing the shuttle valve element 46. The shuttle valve element 46 may be formed with axial ridges 51 from one end to the other to assist in centering the movable shuttle valve element 46 in the tubular valve body 45 and to permit cryogen to flow around it when the valve 40 is in the open position.

FIG. 5 is a sectional view taken along line 5-5 of FIG. 2 showing the cylinder, piston, and magnet assembly. One of the pneumatic couplers 26 communicates with a first passage 31 that leads to the far end of the cylinder 54. The other pneumatic coupler 26 communicates with a second passage 32 that communicates with the near end of the cylinder 54. Seals 39 are provided at the lower end of the housing 12 to maintain pressure in the cylinder 54. Two piston rods 35 are coupled between a U-shaped piston 34, best seen in FIG. 4, and the shell 27 that surrounds the annular magnet 28. FIG. 3 shows the piston rods 35 in a fully retracted position in which the shell 27 surrounding the annular magnet 28 is next to the end of the actuator housing 12.

FIG. 6 is an exploded perspective view of the actuator housing 12 and magnet 28 of FIG. 1. The gap 15 between the legs 14 of the housing is shaped and dimensioned to fit closely around the vacuum insulated line 16. The annular magnet 28 is formed by two semicircular halves 29 that are mounted in the shell 27. The interior of the U-shaped housing 12 contains the U-shaped cylinder 54 and the U-shaped piston 34 having the two piston rods 35 that are coupled to the shell 27. A wiper element 56 is coupled to and moves fore and aft together with the shell 27. The keeper plate 18 contains a cavity 57 for the potentiometer 24, and the end of the wiper element 56 that is in contact with the potentiometer 24. The potentiometer 24 develops signals that are representative of the position of the wiper element 56 on the potentiometer, and the signals are coupled to the signal leads 21 that extend from the potentiometer for connection to outside circuit elements (not shown).

FIG. 7 shows the manner for removing the actuator housing 12 and the magnet 28 from the line 16 without having to break the line 16. The keeper plate 18 is unbolted from the legs 14 of the U-shaped housing 12, freeing the housing to be removed from the line. The threaded fasteners 30 holding the two halves of the shell 27 together are removed allowing the semi-circular magnet halves 29 to be separated and removed from the line 16.

In operation, the position of the piston 34 is controlled by pneumatic fluid that enters the interior of the U-shaped housing 12 through the pneumatic couplers 26. By admitting pneumatic fluid through the passageways 31 and 32 to both sides of the piston 34, the position of the piston can be positively controlled in the cylinder 54 for precise control of the shuttle valve element 46. The movement of the piston 34 is directly transferred by the piston rods 35 to the shell 27 that holds the magnet 28. Movement of the annular magnet 28 causes a corresponding movement of the movable shuttle valve element 46 in the valve 40. As the magnet 28 moves, the wiper 56 moves, and a signal is developed on the linear potentiometer 24 that is indicative of the position of the annular magnet 28, and hence the position of the movable shuttle 46. The signals from the linear potentiometer 24 are used to monitor the position of the annular magnet 28 for feedback control.

The valve 40 is closed when the shuttle 46 is in either the fully upstream or downstream position and one of the tapered ends 48 of the shuttle is pressed against one of the valve seats 43 or 44. Full open flow rates occur in the mid-position of the shuttle 46, half-way between the two valve seats 43 and 44. A smooth metered flow can best be achieved as the shuttle 46 approaches the inlet seat 43. Using the position feedback control derived from signals from the potentiometer 24, it is possible to meter flow though the vacuum insulated line 16 using the in-line valve 40 with negligible heat gain. Flow rates can be precisely controlled by using a programmable actuator to control the position of the magnet 28 and the shuttle valve element 46. In the event of loss of power, fluid drag through the valve will press the shuttle valve element 46 against the outlet seat 44, shutting off flow through the valve.

FIG. 8 shows an alternate form of the actuator that uses a cylindrical piston and cylinder to actuate an in-line control valve. A mounting block 50 may be used to mount a piston assembly 52, a magnetic housing 53, and a position sensor 54 to a vacuum insulated line 16 that may contain a cryogenic fluid stream. The piston assembly 52 may comprise an outer housing 55 for a piston cylinder with a cylindrical bore 56 that contains a cylindrical piston 57. Pneumatic couplers 58 may be provided at either end of the outer housing 55 for coupling to pneumatic lines that are used to position the piston 57 in a desired location within the cylindrical bore 56. The cylindrical piston 57 is coupled to a piston rod 59 that extends out of the housing 55 and through the mounting block 50 and is attached to the magnetic housing 53. The magnet housing 53 contains a magnet (not shown) and slides freely over the vacuum insulated line 16. The magnet in the magnet housing 53 may control a valve similar to the valve 40 shown in FIGS. 2-4 as described above. A rod 64 is connected to the mounting block 50 and extends through a bushing 65 that is mounted in the magnetic housing 53. The position sensor 54 contains a potentiometer (not shown) that is coupled by signal leads 67 to external circuitry. A wire or string 68 extends from the potentiometer and is coupled to the magnet housing 53. A change in position of the magnet housing 53 relative to the mounting block 50 is coupled to the position sensing potentiometer by the string 68, and the potentiometer develops a representative signal that is coupled by the signal leads 67 to external circuitry. The actuator shown in FIG. 8 has the advantage of using a cylindrical piston 57 that fits into a cylindrical bore 56 instead of a U-shaped piston and cylinder as described above and shown in FIGS. 5 and 6. As in the embodiment of FIGS. 1-7, the actuator of FIG. 8 may be installed and removed from the line 16 without having to break the line, the valve within the line does not require a separate vacuum connection in order to be vacuum insulated, and the actuator for the valve element, the magnet housing 53, is not a source of heat gain for the cryogen within the line.

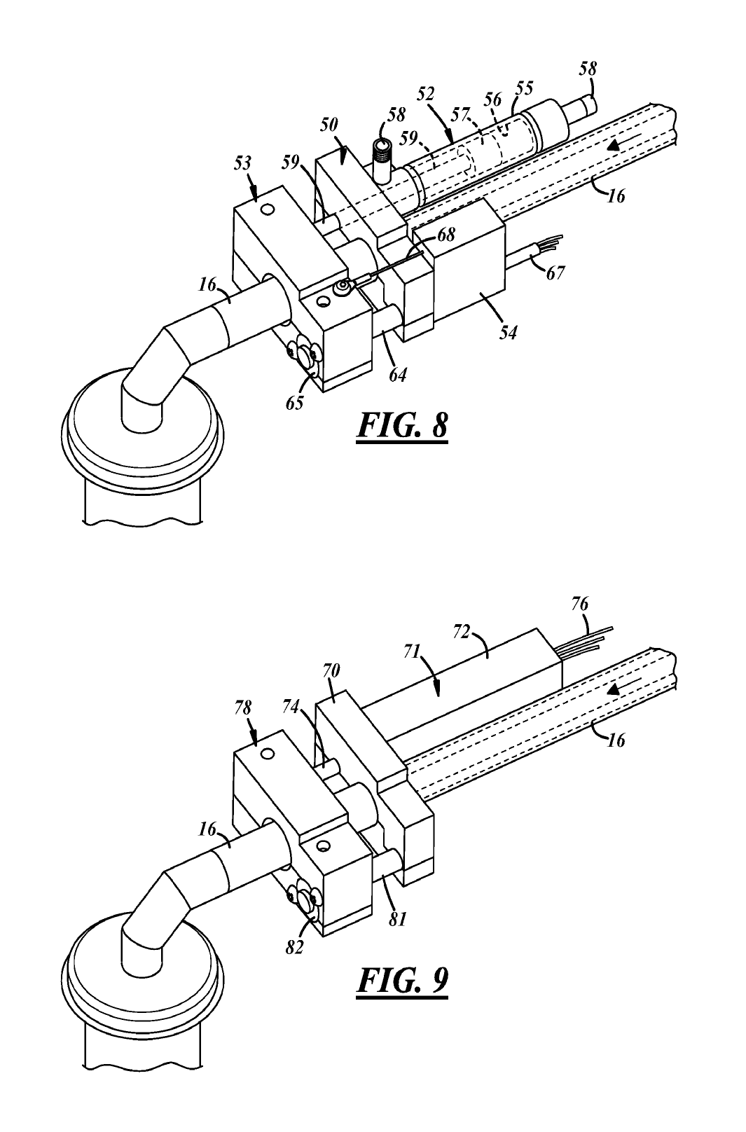

FIG. 9 shows an alternate form of the actuator that uses an actuator with a position sensor to actuate an in-line control valve. A mounting block 70 may be used to mount a housing 71 containing an actuator with a position sensor 72 to a vacuum insulated line 16 that may contain a cryogenic fluid stream. The actuator may be a ballscrew or other linear actuator producing a mechanical displacement in response to an electrical input signal. The position sensor may be a variable differential transformer (LVDT) or other device producing an electrical signal in response to a mechanical displacement. The actuator within the housing 71 is coupled to an output rod 74. The output rod 74 extends or retracts relative to the outer housing 71 in response to an electrical input signal that is applied to the actuator by the signal leads 76. The output rod 74 extends out of the housing 71 and through the mounting block 70 and is attached to a magnet actuator housing 78. The magnet actuator housing 78 contains a magnet and slides freely over the vacuum insulated line 16. The magnet in the magnet actuator housing 78 may control a valve similar to the valve 40 shown in FIGS. 2-4 as described above. A guide rod 81 is connected to the mounting block 70 and extends through a bushing 82 that is mounted in the magnet actuator housing 78. The guide rod 81 and the bushing 82 limit the motion of the magnet actuator housing 78 so that it does not rotate or bind relative to the vacuum insulated line 16. The motion of the output rod 74 is coupled to the LVDT in the housing 71. The resulting signal from the LVDT is used as a feedback control on the signal leads 76 to indicate the position of the magnet actuator housing 78 and thus the shuttle valve element (not shown) in the vacuum insulated line 16. The actuator with an integral position sensor 71 as described herein has the advantage of eliminating the need for pneumatics to actuate a piston in order to change or control the position of the magnet actuator housing 78 and the valve in the vacuum insulated line 16. As in the embodiments described above, the actuator of FIG. 9 may be installed and removed from the line 16 without having to break the line 16, the valve within the line does not require a separate vacuum connection in order to be vacuum insulated, and the actuator itself is not a source of heat gain for the cryogen within the line.

Having thus described the invention, various modifications and alterations will occur to those skilled in the art, which modifications and alterations will be within the scope of the device as defined by the appended claims.

We claim:

1. A valve and an actuator for vacuum insulated line comprising:
a housing that attaches to the vacuum insulated line; and,
a valve positioned in the vacuum insulated line, whereby the vacuum in the vacuum insulated line flows around and surrounds the valve, and insulates the valve from ambient temperature.

2. The valve and actuator of claim 1 further comprising:
a tubular valve body positioned in the vacuum insulated line; and,
a movable shuttle valve element mounted in the tubular valve body, the shuttle valve element controlling the flow of material through the vacuum insulated line.

3. The valve and actuator of claim 2 further comprising:
at least one seat in the tubular valve body, the shuttle valve element moving away from the annular seat to allow material flow through the valve and moving toward the annular seat to block material flow through the valve.

4. The valve and actuator of claim 3 wherein the material comprising the shuttle valve element is attracted to the magnet.

5. The valve and actuator of claim 3 further comprising:
opposed tapered ends on the shuttle valve element; and,
an inlet seat and an outlet seat in the tubular valve body, whereby the valve is closed when one of the tapered ends of the shuttle valve element is pressed against either the inlet seat or the outlet seat.

6. The valve and actuator of claim 5 wherein full open flow rates for the valve occur in the mid-position of the shuttle valve element, half-way between the inlet seat and the outlet seat.

7. The valve and actuator of claim 5 wherein in the event of loss of power, fluid drag through the valve will press the shuttle valve element against the outlet seat, shutting off flow through the valve.

8. The valve and actuator of claim 1 further comprising:
two legs forming part of the housing; and,
a gap formed between the two legs, whereby the gap is shaped and dimensioned to fit closely around the vacuum insulated line.

9. The valve and actuator of claim 8 further comprising:
a U-shaped cylinder formed in the housing and a U-shaped piston contained in the U-shaped cylinder; and,
a magnet coupled to the U-shaped piston, whereby motion of the U-shaped piston causes motion of the magnet and actuates the valve.

10. The valve and actuator of claim 9 further comprising:
at least one piston rod coupling the U-shaped piston to the magnet, whereby motion of the U-shaped piston causes a corresponding motion of the magnet.

11. The valve and actuator of claim 10 further comprising:
an annular magnet comprising the magnet, whereby the annular magnet surrounds the insulated line in that portion of the insulated line that contains the valve.

12. The valve and actuator of claim 11 further comprising:
two semicircular halves comprising the annular magnet, whereby the semicircular halves can be separated to remove the annular magnet from the line.

13. The valve and actuator of claim 12 further comprising:
a keeper plate mounted on the ends of the two legs of the housing, the keeper plate and the two legs surrounding and securing the housing on the vacuum insulated line.

14. The valve and actuator of claim 13 wherein the keeper plate can be removed from the ends of the two legs of the housing to remove the housing from the vacuum insulated line.

15. The valve and actuator of claim 14 further comprising:
a potentiometer for developing signals representing the position of the piston, the potentiometer being attached to the housing.

16. The valve and actuator of claim 15 further comprising:
a wiper element mounted on the annular magnet and being in contact with the potentiometer, whereby motion of the magnet results in motion of the wiper element.

17. The valve and actuator of claim 15 wherein the signals representing the position of the piston may be used to monitor the position of the annular magnet for feedback control.

18. The valve and actuator of claim 1 further comprising:
a mounting block attached to the vacuum insulated line;
a cylindrical piston having a piston rod and a piston cylinder attached to the mounting block; and,
a magnet housing that slides freely over the vacuum insulated line to control the valve, whereby the motion of the cylindrical piston and the piston rod controls the motion of the magnet housing to control the valve.

19. The valve and actuator of claim 1 further comprising:
a mounting block attached to the vacuum insulated line;
a housing containing an actuator and a position sensor attached to the mounting block;
a magnet housing that slides freely over the vacuum insulated line to control the valve; and,
an output rod coupling the actuator to the magnet housing; whereby motion of the output rod causes a motion of the magnet housing to control the valve and the position sensor senses the motion of the output rod.
